(19) United States
(12) Patent Application Publication
(10) Pub. No.: US 2015/0301988 A1
(43) Pub. Date: Oct. 22, 2015

(54) SYSTEM AND METHOD FOR MANAGING ELECTRONIC PERIODICALS ON A COMPUTING DEVICE

(71) Applicant: Kobo Inc., Toronto (CA)

(72) Inventors: Anthony O'Donoghue, Toronto (CA); Sneha Patel, Mississauga (CA)

(73) Assignee: Kobo Inc., Toronto (CA)

(21) Appl. No.: 14/258,918

(22) Filed: Apr. 22, 2014

(51) Int. Cl. G06F 17/21; G06F 3/0483

(52) U.S. Cl. CPC G06F 17/212; G06F 3/0483

(57) ABSTRACT

A computing device operates to receive a current issue of an electronic periodical. In response to receiving the current issue, the computing device performs one or more actions to remove at least the content portion of at least one prior issue of the electronic periodical that was download on the computing device. Metadata content is displayed to represent a collection of issues for the electronic periodical that were acquired for download for an account associated with the computing device. The collection of issues includes the current issue and at least one prior issue the electronic periodical. The metadata content that is displayed to represent the collection can be based at least in part on a metadata portion of the current issue.

### TECHNICAL FIELD

Examples described herein pertain to a system and method for managing electronic periodicals on a computing device.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-books is displayed as alphanumeric characters and/or graphic images on a display of an e-reader device such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose built devices designed that perform especially well at displaying readable content. For example, a purpose built e-reader device may include a display that reduces glare, performs well in high light conditions, and/or mimics the look of text on actual paper. While such purpose built e-reader devices excel at displaying content for a user to read, they may also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device as an e-reader device to manage electronic periodicals, according to an embodiment.

FIG. 2 illustrates an example of an e-reader device or other electronic personal display device, for use with one or more embodiments described herein.

FIG. 3 illustrates an e-reader system for providing a periodical management system, in accordance with one or more embodiments described herein.

FIG. 4 illustrates a method for managing a periodical on the e-reader device, according to one or more embodiments.

FIG. 5A and FIG. 5B illustrate an example of an interface in which metadata content represents multiple issues of a periodical that belong to a account associated with a device, according to some embodiments.

### DETAILED DESCRIPTION

Examples described herein provide for a system and method to manage electronic periodicals on a computing device. In particular, a computing device is programmed to manage the representation of an electronic periodical on a computing device. Furthermore, in some examples, the computing device is programmed to manage the archival of prior issues of the electronic periodical.

In an embodiment, a computing device operates to receive a current issue of an electronic periodical. In response to receiving the current issue, the computing device performs one or more actions to remove at least the content portion of at least one prior issue of the electronic periodical that was previously downloaded on the computing device. Metadata content is displayed to represent a collection of issues for the electronic periodical that were acquired for download using the computing device. The collection of issues includes the current issue and at least one prior issue of the electronic periodical. The metadata content can be based at least in part on a metadata portion of the current issue.

In some implementations, the metadata portion of the current issue is displayed in prominence. For example, (i) the metadata portion of the current issue to be more visually distinguishable than the metadata portion of any other issue of the collection, and/or (ii) the metadata portion of only the current issue of the collection without displaying the metadata portion of any other issue of the collection.

As used herein, an “electronic periodical” is a type of “e-book” and includes a title for which issues are published on a periodical or repetitive basis. An example of an electronic periodical is an electronic magazine. Often, electronic periodicals such as magazines mirror print versions and recreate the paginated experience, with text and illustrations being reproduced digitally. In the example of the electronic magazine, the title of the periodical can correspond to the name of the magazine, and issues of the magazine can publish on a periodic basis (e.g., monthly). Other examples of electronic periodicals include electronic comic books, newspapers, and scientific and legal journals.

Among other benefits, examples described herein conserve display space in representing issues of a periodical that belong to the user library. Additionally, examples described herein facilitate archiving of issues in order to conserve memory resources of the computing device. Still further, examples described herein condense the representation of a periodical so as to display a current issue of the periodical in prominence, while providing indicia about the archival status of prior issues of the periodical through the periodical's graphic representation.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Network System Description

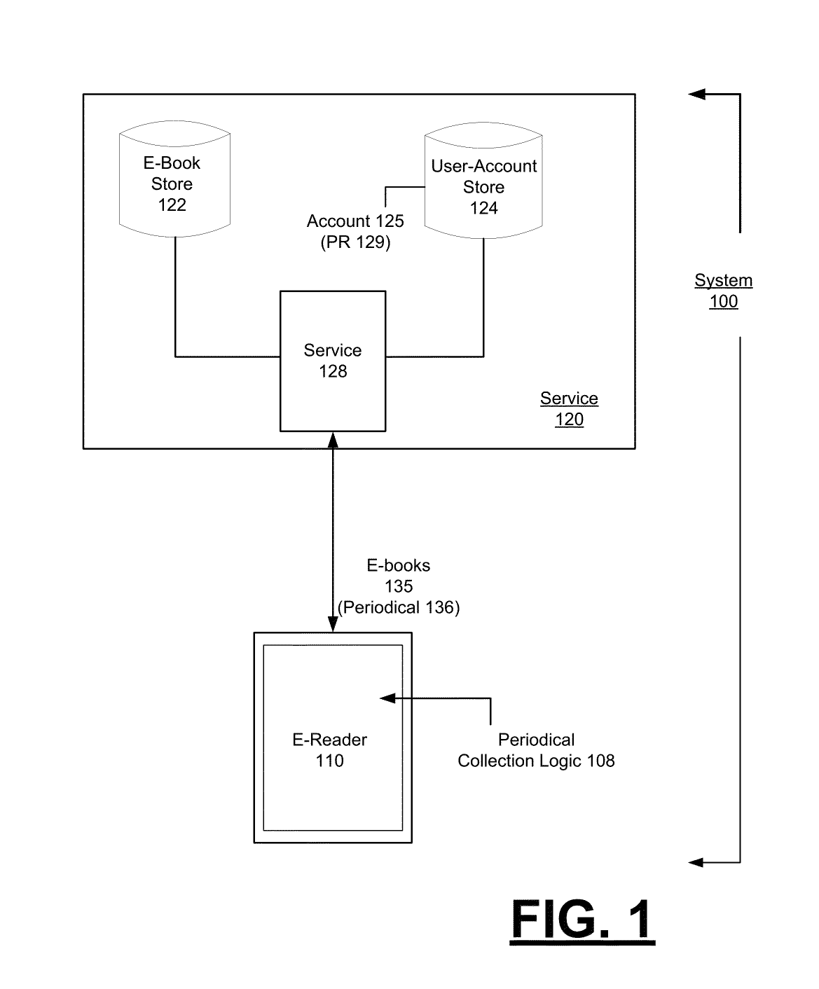

FIG. 1 illustrates a system for operating a computing device to manage electronic periodicals, according to an embodiment. In an example of FIG. 1, system 100 includes an electronic display device, shown by way of example as an e-reader device 110, and a network service 120. The network service 120 may include multiple servers and other computing resources that provide various services in connection with one or more applications that are installed on the e-reader device 110. By way of example, in one implementation, the network service 120 can provide e-reading services which communicate with the e-reader device 110. The e-reading services provided through network service 120 can, for example, include services in which e-books (including electronic periodicals) are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books such as electronic periodicals, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books such as electronic periodicals). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books including electronic periodicals), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books including electronic periodicals) that are purchased or otherwise made available to the user of the e-reader device 110, as well as to archive e-books and other digital content items that have been purchased for the user account 125, but are not stored on the particular computing device.

With reference to FIG. 1, the e-reader device 110 implements periodical collection logic 108 to conserve memory resources and present periodical collections for a user. In one implementation, the e-reader device 110 receives e-books 135 from the network service 120. The e-books 135 can include, by way of example, electronic works such as novels and non-fiction titles, as well as periodicals 136, such as electronic magazines and comic books. The periodical collection logic 108 can selectively display a single display object, or alternatively, a collated set of display objects, to represent the electronic periodical and the issues that the user has purchased or downloaded. At the same time, the periodical collection logic 108 can implement memory management resources in order to remove, or facilitate removal of portions of periodicals that are not current.

In removing portions of periodicals that are not current, the periodical collection logic 108 can operate in conjunction with the network service 120 to provide archiving services for the removed periodical. In particular, the user account store 124 can maintain records of the periodical and/or periodical issues (“periodical records 129”) that the user has downloaded, or has otherwise received right to download or view from the network service 120. The periodical collection logic 108 can remove or trigger removal of prior issues of a given periodical, and further enable the user to download archived issues of the periodical on selection.

Embodiments described herein recognize that with regard to periodicals, users tend to (i) view a periodical only until they have completed the periodical, but not after, and (ii) forego back issues of periodicals when a new issue of the periodical becomes available. Among other benefits, the periodical collection logic 108 can trigger, in response to the receipt of a current issue of a particular periodical, removal of one or more prior issues of the periodical from the e-reader device 110. In particular, the periodical collection logic 108 can remove a content portion of some or all of the prior issues of the periodical, while maintaining metadata for the archived prior issues in order to provide graphical representation for those issues. The graphical representations provided with archived issues of the periodical can also be provided with functional features that enable the user to download the respective archived issues from the network service 120.

Hardware Description

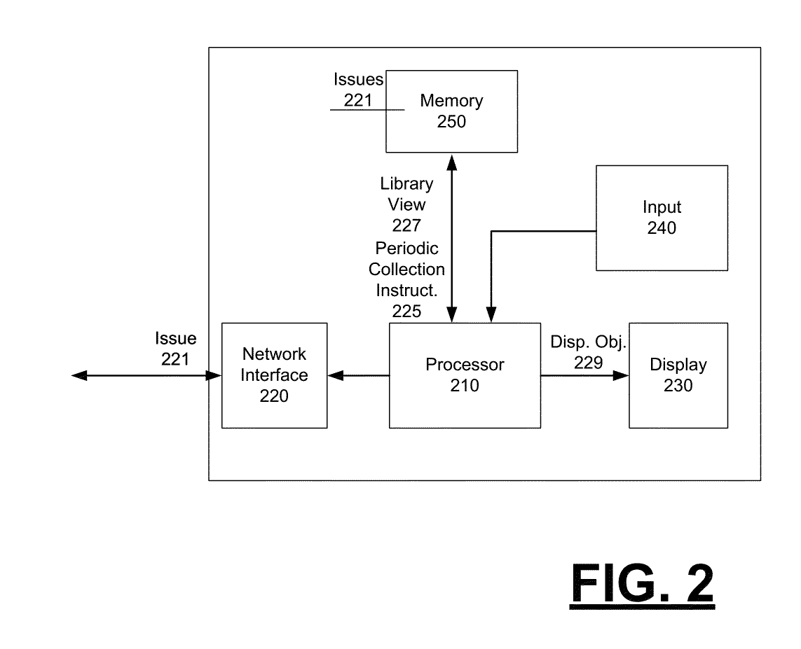

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books or media files that the user elects to purchase or otherwise download from the network service 120. In examples described herein, the e-reader device 200 receives application resources corresponding to issues 221 of a periodical (e.g., magazine, comic book). The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display which mimics conventional paper in the manner in which it displays content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or keyboard) or other input mechanisms (accessory devices). In one implementation, the processor 210 can process touch or mufti-touch input detected by the sensor layer provided with the display 230.

In an example of FIG. 1, the processor 210 can access instructions for implementing the period collection logic 108 (see FIG. 1) (“periodic collection instructions 225”). In one implementation, the processor 210 executes the periodical collection instructions 225 as part instructions to provide a library view (“library view instructions 227”) of e-books in a user's library. The periodical collection instructions 225 can be executed by the processor 210 to provide a single display object 229 as the graphic representation of the periodical. In addition to displaying metadata content for the current issue of the periodical, the display object 229 can provide indicia of one or more prior issues of periodical, including graphic representation of the archival status of the one or more prior issues. Alternatively, the periodical collection instructions 225 can be executed by the processor 210 to provide a condensed or overlapping set of display objects 229 to represent the available issues of a periodical for rendering on the display 230. The display object(s) 229 for the periodical can be based primarily on the metadata content of the current issue 221. As an addition or variation, the display object(s) 229 for the periodical can display metadata content from multiple issues of the periodical, with the current issue being displayed in prominence (e.g., highlighted and/or placed in foreground).

E-Reader System

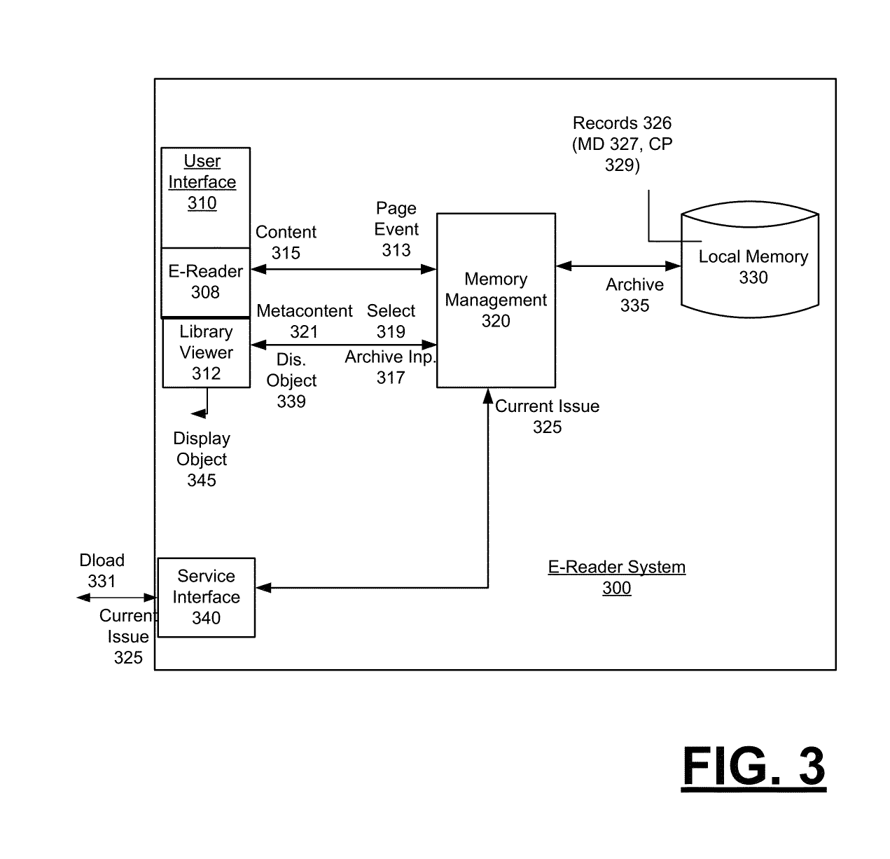

FIG. 3 illustrates an e-reader system for managing the issues of electronic periodicals on a computing device, in accordance with one or more embodiments described herein. In reference to FIG. 3, an e-reader system 300 implements programmatic components for communicating with an e-book service (such as network service 120, shown in FIG. 1), as well as for enabling functionality for viewing and accessing e-books (including periodicals) utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the e-reader system 300 can be provided in part as operating system-level components. Alternatively, the programmatic components shown with the e-reader system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein, as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection, to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books from the network service 120. For example, in identifying the e-reader device 110 of system 300 to the network service 120, the network service may be able to procure payment information (e.g., stored credit card information) that can be used to charge the users account when the user purchases a new e-book from the service.

The e-books that are retrieved by the e-reader system 300 can correspond to issues of an electronic periodical, characterized by a periodical title (e.g., “Fields and Streams” or “Men's Journal”) and publisher. The individual periodical can have issues which publish on a periodic basis (e.g., monthly, weekly, etc.). An issue may be associated with the month and year, or with a volume number. For example, the periodical can be the format of the magazine, comic book, newspaper, journal (e.g., scientific or trade journal, law journal), newsletter etc. The e-books, including issues of individual periodicals, can be provided with metadata, which can include, for example, graphic imagery representing a cover of the e-book, as well as text content describing the publisher, contributors (e.g., authors), summaries and other information. In order to obtain the right to view the periodical, a user can purchase, for example, a subscription to the periodical from network service 120. Alternatively, the user can purchase individual issues without obtaining a subscription. When the user obtains a subscription, one implementation provides for the network service 120 to push a newly published issue (current issue 325) to one or more devices of the e-reader system 300. In a variation, a notification or other communication may be communicated to the device of e-reader system 300 in order to inform the user that the current issue 325 is available for download.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. As another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

With reference to FIG. 3, the e-reader system 300 receives the current issue 325 of a given periodical. The e-reader system 300 can receive current issues 325 for one or more periodicals on an ongoing basis, and each new current issue 325 can add to the collection of issues for the periodical. The current issue 325 can include a metadata portion 327 and a content portion 329. The content portion 329 of the issues of the periodical can include text, images and/or media which are rendered to the user through, for example, an e-reader component of the user interface 310. The metadata portion 327 of the each issue of the periodical can include, for example, (i) an iconic image of cover for the issue, including cover photo and/or accompanying text; (ii) identification of the issue (e.g., by volume number or date); and/or (iii) text or image information about the periodical (not issue specific). The memory management module 320 receives the current issue 325, and stores the current issue 325 (including the metadata and content portion 327, 329) as a record 326 in the memory resources 330.

In an example of FIG. 3, the user interface 310 of e-reader system 300 includes an e-reader component 308 and a library viewer 312. The e-reader component 308 can operate to render portions of a selected e-book (e.g., one or more page from a periodical such as a magazine) through the display of the device of e-reader system 300. Additionally, the e-reader component 308 can provide one or more input features for enabling the user to interact and respond to pages of a rendered e-book. The input features can include, for example, touch sensitive regions that the user can contact in order to cause a page events 313. The page event 313 can correspond to an instruction to transition pages of the e-book, either individually, by clusters or by sections. In one implementation, memory management module 320 receives the page event 313, and responds to the page event 313 by retrieving updated content 315 from the memory 330. The updated content 315 can be identified by the page event 313 for the particular e-book that is being accessed and viewed through the e-reader component 308. In this way, the user can interact with the e-reader component 308 in order to transition pages of an e-book.

The library viewer 312 can display metadata content that represents the e-books and other content items in the library. The user's library includes, for example, e-books and/or collections of issues for one or more periodicals. The metadata content can be in the form of, for example, lists or other clustered display objects. Still further, the library viewer can display metadata content in various paradigms or virtual objects, such as through a virtual bookshelf. In one implementation, the library viewer 312 displays metadata content 321 in the form of display objects 339 which individually represent a collection of issues for the periodical. The display object(s) 339 can this be based on metadata portions 327 of individual e-books associated with the user's library. For each issue of a given periodical, the metadata portions 327 can include, for example, an image associated with a cover. When displayed through the device of e-reader system 300, the image can be iconic and stored as part of the record 326 for the particular issue. The metadata content 321 for a particular periodical can include display objects 339 which are based on graphic images that are provided with the metadata portion 327 of one or more issues (e.g., current issue) of the particular periodical.

The e-books that are associated with the user's library can reside on the device of e-reader system 300, or alternatively reside off of the device, but available for download. By way of example, some items in the user's library can be archived. Those items which are archived can have portions which are not stored on the device. For example, an archived e-book can be represented locally by metadata content that is based on the metadata portion 327 of that item, but the content portion 329 of that item can be deleted or otherwise removed from the device. Should the user wish to view the content of an archived item, the user can download the content portion from the network service 120. As another variation, a given item can be stored on a different device of the account associated with the e-reader system 300.

The library viewer 312 can include the display objects 339 that are based on the metadata portions 327 of both locally stored e-books and off-device e-books (e.g., archived). In the case of periodicals, the library viewer 312 can display metadata content 321 to represent both archived and resident issues of the periodical which the user has acquired. In one implementation, the metadata content 321 can be in the form of display object 339 that include an icon or cluster of icons, which correspond to the graphic images of the periodical, or of individual issues of the periodical. In a variation, the display object 339 of the metadata content 321 can represent the issues of the periodical as a set of icons that are clustered and made to overlap so as to appear (or alternatively form) a single display object.

In one implementation, the metadata content 321 for a given periodical can be based primarily (e.g., more than 50% of the metadata content 321 for the periodical) on the metadata portion 327 of the current issue 325. As an alternative or addition, the metadata content 321 for the given periodical can display the graphic representation of the current issue in prominence. The graphic representation of the current issue 325 can be placed in prominence by, for example, (i) highlighting or bolding the graphic representation relative to other aspects of metadata content 321, and/or (ii) placing the graphic representation of the current issue 325 in the foreground for the metadata content 321. Still further, the prominence for rendering the graphic representation of the current issue 325 can be achieved by deemphasizing other aspects of the metadata content 321 representing prior issues of the corresponding periodical. In this way, the library viewer 312 can use the metadata content 321 to graphically represent the issues in the user's library for a given periodical as either a single display object, or as a clustered or over-lapping set of display objects.

According to some embodiments, the memory management module 320 implements archiving functions in response to receiving the current issue 325 of the given periodical. Specifically, the memory management module 320 can perform one or more operations to remove at least the content portion 329 of one or more prior issues of the given periodical in response to receiving a current issue 325. According to one aspect, the memory management module 320 can remove the content portion 329 of the most recent prior issue stored in the memory 330 upon receipt of the current issue 325. In this way, the archiving of the e-book (including issues of periodicals) does not remove at least some of the metadata portion 327 associated with the archived e-books. The metadata portion 327 for an archived e-book can be used to display that e-book as part of the uses collection using, for example, library viewer 312.

In one embodiment, the memory management module 320 can remove the content portion 329 of a prior issue of the same periodical automatically in response to receipt of the current issue 325. In a variation, the memory management module 320 prompts the user to provide confirmation for removing the content portion 329 of the prior issue of the same periodical. Thus, for example, if the user has not completed reading a most recent prior issue of the periodical, the memory management module 320 will not automatically cause a prior issue of a periodical to be archived when a current issue of the same periodical is received.

In one implementation, the archival function can be implemented using logic integrated with the memory management module 320. The memory management module 320 can signal an archival operation 335 that causes memory resources 330 to delete or otherwise removed the content portion 329 of an identified issue of a given periodical. At the same time, the memory management module 320 can link the metadata portion 327 of the e-book with functionality that (i) links an identifier of the archived issues with the user account, and (ii) triggers with selection input to communicate with a network service and initiate a download process for the identified issue of the periodical. In this way, when an issue of a periodical is archived, functionality can be associated with display objects that represent the archived issues for purpose of facilitating the download of the content portion 329 upon user selection.

The prior issue that is selected for archiving can correspond to the most recent prior issue and/or the oldest prior issue of the periodical that received the current issue 325. Still further, in one variation, all prior issues of the periodical can be archived in response to a current issue 325 being received.

The library viewer 312 can display lists in various formats to represent the user's collection of e-books. As mentioned, the library viewer 312 can utilize metadata content 321 such as display objects 339 to display specific e-books and periodicals. When providing display object representing a given periodical, examples described herein recognize that one or more (but not all) of the multiple issues of the periodical may be archived. In one implementation, the metadata content 321 can be used to generate the display object 339 that represents the periodical and the plural issues that belong to the account associated with the e-reader system 300. The display object 339 for the periodical can be based primarily on the current issue. Alternatively, the display object 339 can be displayed in a format relative to the graphic representation of other issues that emphasizes the current issue over other issues. Furthermore, in some variations, the display object 339 representing the periodical can indicate graphically that some of the issues are archived. For example, an icon corresponding to the metadata portion 327 of the current issue can sit on top of multiple icons representing prior issues of the same periodical in a staggered arrangement. The icons of the prior issues can be shown in phantom to represent archive status. Furthermore the icon of the current issue can be shown in bold or otherwise highlighted in order to emphasize that the particular issue is the one that is current and/or resident on the device.

In one implementation, when the current issue 325 of a given periodical is received, the library viewer 312 can be used to display to the user a prompt for selecting whether one or more prior issues are to be archived. The user can respond with archive input 317 which specifies or otherwise selects the archiving function for a specified issue of the periodical. The memory management module 320 responds to the archival input 317 by issuing the archival operation 335 to remove at least the content portion 329 of the specified issue.

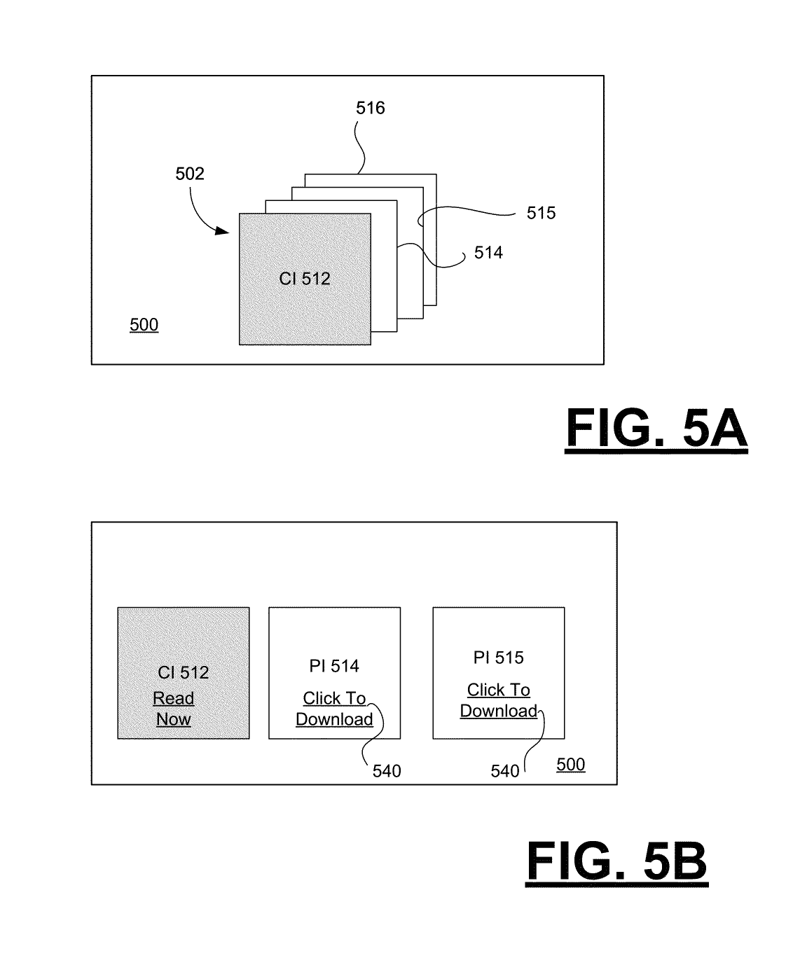

Still further, in one implementation, when the display object 339 of the periodical is displayed, selection of the display object can have different results, depending on the implementation of the e-reader system 300. In one implementation, user selection of the display object 339 results in the expansion of the components of the display object. Specifically, as shown by an example of FIG. 5B, the graphic representations of individual issues that have been acquired by the account for the particular periodical can be displayed individually, such as in a panel or list.

In some embodiments, those issues of the periodical which are archived can have the graphic representations altered in a manner that reflects the archive status of that particular issue. In one implementation, the archive periodicals are provided with functional indicia that indicates the user can make selection to download the content portions of those issues. For example, the library viewer 312 can display graphic representations of individual issues of a periodical, including those that are archived, and the graphic representations of the archived issues can be provided with a “tap to download” link that indicates the archive status. The user can provide selection input 319 by activating the link. The selection input 319 triggers the memory management module 320 to signal download command 331 to the network service 120 (see FIG. 1) via the service interface 340. The download command 331 can identify the particular issue of the periodical that was selected, as well as the user account and other identifiers that are necessary for the network service 120 to fulfill the download command automatically in response to issuance of the download command 331.

Methodology

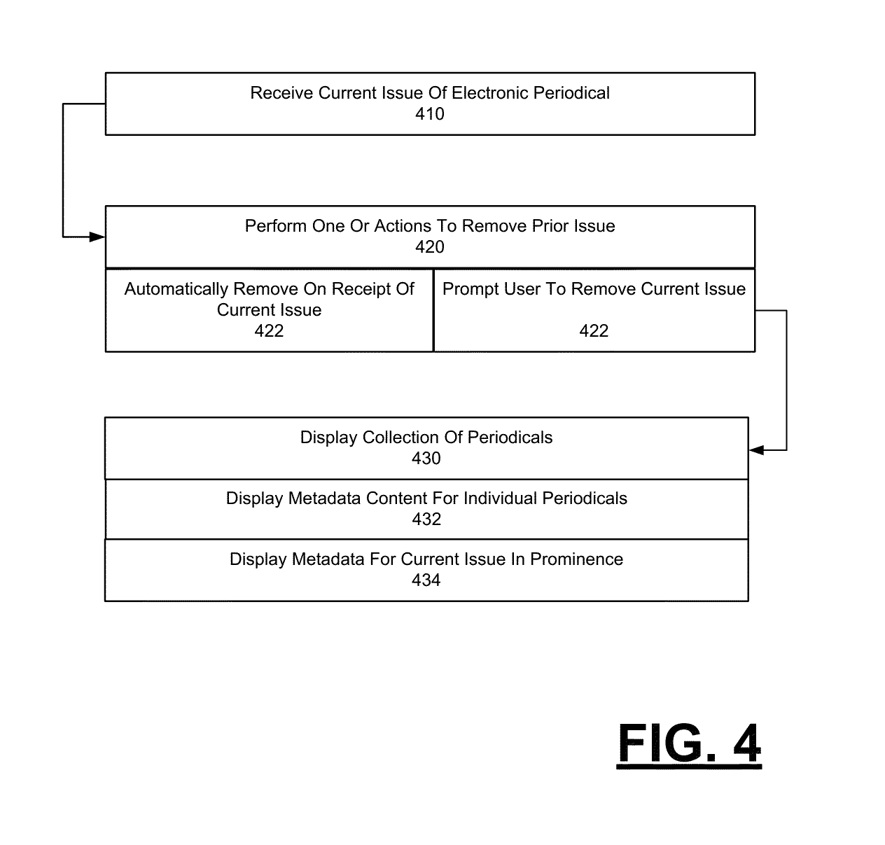

FIG. 4 illustrates a method for managing a periodical on an e-reader device, according to one or more embodiments. A method such as described by an example of FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, the current issue of the periodical is received on an e-reader device 110 (410). The user can, for example, subscribe to the periodical, and a network service 120 can push or otherwise notify the user when the current issue becomes available. In this way, the e-reader device 110 of a given account can repeatedly receive issues of a periodical over the course of a duration (e.g., one year). For example, in an annual subscription, the e-reader device 110 can receive monthly issues of a magazine or comic book based on a subscription plan that the service 120 maintains for the account 125 of the user.

According to an embodiment, when the current issue is received, the e-reader device 110 performs one or more operations to archive a prior issue (or multiple prior issues) of the periodical (420). For example, the most recent prior issue, the oldest prior issue, or all of the prior issues of the periodical that are stored locally on the receiving device of the current issue can be identified for archival operations 335. In one implementation, the memory management module 320 performs the operation of automatically removing at least some of the content portion 329 of one or more prior issues upon receipt of the current issue 325 (422). In a variation, the user is prompted to remove at least some of the content portion of one or more prior issues in response to receiving the current issue. For example, the memory management module 320 can signal a message or notification to the user that allows the user to provide archival input 317. In turn, the memory management module 320 signals the archival operation 335, which identifies or otherwise selects one or more prior issues for archiving.

Additionally, the periodical can be represented as part of the user library on the e-reader device 110 (430). An icon or other graphic representation for the periodical as a whole can be provided by the library viewer 312. By way of example, the library viewer 312 can provide the graphic representation to be in the form of a list or panel of items that represent different e-books or content items that are associated with the account of the device. In one implementation, the graphic representation of the periodical can be in the form of metadata content that utilizes the metadata portion 327 of one or multiple issues of the periodical (432). Still further, the metadata content can be based primarily on the metadata portion 327 of the current issue of that periodical (434). In this way, the metadata portion 327 of the current issue 325 can be emphasized when the graphic representation of the periodical is being displayed. By way of example, the metadata portion 327 of the current issue 325 can be highlighted, place in the foreground, or emboldened as compared to the graphic representation of one or more prior issues. FIG. 5A provides an example of a graphic representation of a periodical, in which the current issue is highlighted or otherwise made the basis for the graphic representation of the periodical as a whole.

### EXAMPLES

FIG. 5A and FIG. 5B illustrate an example of an interface in which metadata content represents multiple issues of the periodical that belong to a account associated with a device, according to some embodiments. Examples such as provided with FIG. 5A and FIG. 5B can be implemented using, for example, a system such as described with FIG. 1, a device such as described with FIG. 2, and/or an e-reader system such as described with FIG. 3. Accordingly, reference may be made to elements of FIG. 1, FIG. 2 and/or FIG. 3 to illustrate suitable components for implementing the example provided.

With reference to FIG. 5A, an interface 500 can be generated by the library viewer 312 to display a representation of at least a portion of the electronic library associated with an account of a given e-reader device or system. The interface 500 can display entries corresponding to individual periodicals in the form of, for example, a panel (as shown) or list. A display object 502 can represent the periodical in the representation of the user library. In the example provided, the display object 502 can include a foreground object corresponding to the current issue, and one or more background object that represent prior issues. Other paradigms or structures can be used in order to represent multiple issues of a given periodical associated with the user account. The display object 502 can be structured as a single icon in which prior issues are indicated using line elements, as well as potentially metadata content from the records of those prior issues. In one implementation, foreground object 512 can be based at least in part on the metadata content of the current issue. The foreground object 512 can also carry data that corresponds to the title the periodical, as well as other information such as the summary of the periodical and/or the last download activity related to the periodical. The aspects of the foreground object 512 that can be based on the current issue include, for example, the graphic representation of the current issue (e.g., cover a magazine, rendered in iconic form).

In one implementation, the display object 502 is based on metadata content of the current issue of the periodical. The current issue can correspond to the most recent issue of the periodical, or alternatively to the most recent issue of the periodical that is resident on the device or otherwise acquired by the account associated with the device. In one example, the foreground object 512 can be based primarily on the metadata portion 327 of the current issue 325.

In one implementation, the display object 502 is selectable by the user in order to expand the representation to depict the graphic representation of the current issue and multiple prior issues. Thus, for example, the display object 502 can be treated as a single icon that is selectable in order to expand the graphic representations of the issues that comprise the periodical for the particular user account.

Alternatively, the display object 502 can comprise multiple background objects 514, 515, 516 of prior issues of the same periodical. The user can individually interact with foreground object 512 as well as the background objects 514 515 and/or 516. In this way, the user selection of a particular object can result in an action being performed on the particular object, such as retrieval and/or opening of the issue represented by the selected object. If the selected object is a prior issue that has been archived, the memory management module 320 can retrieve the content portion 329 of that issue from the network service 120. If the selected object re sides locally on the device (e.g., current issue 325), the memory management module 320 opens the content portion 329 of the selected issue using the locally stored data.

FIG. 5B illustrates an example in which the display object 502 can be selected in order to expand the graphic representations of the background objects 512, 514, 515, 516, representing the prior issues that comprise the periodical on the e-reader device 110. Once expanded, the interface 500 can be used to render the graphic representations of the current issue (foreground object 512), and the background objects 514, 515, 516 representing one or more prior issues. For example, as shown with FIG. 5B, the background objects 5514, 515, and 516 can be displayed side-by-side or in the panel arrangement. As mentioned with some examples, some or all the prior issues can be archived.

In some embodiments, the background objects 514, 515, and 516 can be provided with a functional indicia 540 that enables the individual to download that particular archived issue (e.g., download the content portion 329 of the archived issue). In one implementation, the interface 500 can be rendered through the library viewer 312, or other user interface component. The memory management module 320 can be triggered by selection of the functional indicia 540, causing the memory management module 320 to signal via the service interface 340 to access and download the content portion 329 of the identified issue from network service 120. Further, an example of FIG. 5B also illustrates that the foreground object 512 of the current issue can be highlighted or otherwise placed in prominence even without placing the current issue in in the foreground of the display object 502.

Although embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
(a) receiving a current issue of the electronic periodical;
(b) in response to receiving the current issue, performing one or more actions to remove at least a content portion of at least one prior issue of the electronic periodical that was downloaded on the computing device; and
(c) displaying metadata content representing a collection of issues for the electronic periodical that were acquired for download for an account associated with the computing device, the collection of issues including the current issue and the at least one prior issue of the electronic periodical;
wherein displaying the metadata content includes displaying a metadata portion of the current issue in prominence relative to any other issue of the collection.

2. The method of claim 1, wherein (b) includes removing the content portion of the at least one prior issue automatically in response to receiving the current issue.

3. The method of claim 1, wherein (b) includes prompting the user to remove the content portion of the at least one prior issue, then removing the content portion of the at least one prior issue in response to user input.

4. The method of claim 1, wherein (c) includes displaying metadata content corresponding to metadata portion of multiple issues of the collection as one display object representing the collection.

5. The method of claim 1, further comprising maintaining the collection, including associating the metadata portion of multiple prior issues of the periodical with the collection that have had a content portion of the multiple prior issues removed from the computing device.

6. The method of claim 5, further comprising enabling a user of the computing device to download the content portion of each of the multiple prior issues by interacting with an object that includes the metadata portion of that prior issue.

7. The method of claim 1, wherein displaying the metadata portion of the current issue in prominence includes one or more of (i) displaying a graphic image of the metadata portion of the current issue in a foreground while displaying a graphic representation of one or more of the at least one prior issue in a background, or (ii) distinguishing the graphic image of the metadata portion of the current issue relative to the graphic representation of one or more of the at least one prior issue.

8. The method of claim 1, wherein (a) and (b) are performed automatically in response to a network service event.

9. A computing device comprising:
a memory that stores a set of instructions;
one or more processors that access the set of instructions to:
receive a current issue of the electronic periodical;
in response to receiving the current issue, perform one or more actions to remove at least a content portion of at least one prior issue of the electronic periodical that was downloaded on the computing device; and
display metadata content representing a collection of issues for the electronic periodical that were acquired for download for an account associated with the computing device, the collection of issues including the current issue and the at least one prior issue of the electronic periodical;
wherein the one or more processors display the metadata content by displaying a metadata portion of the current issue in prominence relative to any other issue of the collection.

10. The computing device of claim 9, wherein the one or more processors perform the one or more actions by removing the content portion of the at least one prior issue automatically in response to receiving the current issue.

11. The computing device of claim 9, wherein the one or more processors perform the one or more actions by prompting the user to remove the content portion of the at least one prior issue, then removing the content portion of the at least one prior issue in response to user input.

12. The computing device of claim 9, wherein the one or more processors display metadata content representing the collection of issues by displaying metadata content corresponding to metadata portion of multiple issues of the collection as one display object representing the collection.

13. The computing device of claim 9, wherein the one or more processors access the set of instructions to maintain the collection, including associating the metadata portion of multiple prior issues of the periodical with the collection that have had a content portion of the multiple prior issues removed from the computing device.

14. The computing device of claim 13, wherein the one or more processors access the instructions to enable a user of the computing device to download the content portion of each of the multiple prior issues by interacting with an object that includes the metadata portion of that prior issue.

15. The computing device of claim 9, wherein the one or more processors display the metadata portion of the current issue in prominence by performing one or more of (i) displaying a graphic image of the metadata portion of the current issue in a foreground while displaying a graphic representation of one or more of the at least one prior issue in a background, or (ii) distinguishing the graphic image of the metadata portion of the current issue relative to the graphic representation of one or more of the at least one prior issue.

16. A computer-readable medium that stores instructions for operating a computing device, the instructions being executable by one or more processors of a computing device to cause the computing device to perform operations that include:
(a) receiving a current issue of the electronic periodical;
(b) in response to receiving the current issue, performing one or more actions to remove at least a content portion of at least one prior issue of the electronic periodical that was downloaded on the computing device; and
(c) displaying metadata content representing a collection of issues for the electronic periodical that were acquired for download for an account associated with the computing device, the collection of issues including the current issue and the at least one prior issue of the electronic periodical;
wherein displaying the metadata content includes displaying a metadata portion of the current issue in prominence relative to any other issue of the collection.

17. The computer-readable medium of claim 16, wherein (b) includes removing the content portion of the at least one prior issue automatically in response to receiving the current issue.

18. The computer-readable medium of claim 16, wherein (b) includes prompting the user to remove the content portion of the at least one prior issue, then removing the content portion of the at least one prior issue in response to user input.

19. The computer-readable medium of claim 16, wherein (c) includes displaying metadata content corresponding to metadata portion of multiple issues of the collection as one display object representing the collection.

20. The computer-readable medium of claim 16, further comprising instructions for maintaining the collection, including associating the metadata portion of multiple prior issues of the periodical with the collection that have had a content portion of the multiple prior issues removed from the computing device.
